(19) United States
(12) Patent Application Publication
(10) Pub. No.: US 2009/0201282 A1
(43) Pub. Date: Aug. 13, 2009

(54) METHODS OF TUNING INTERFEROMETRIC MODULATOR DISPLAYS

(75) Inventor: Alok Govil, Santa Clara, CA (US)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM MEMS Technologies, Inc, San Diego, CA (US)

(21) Appl. No.: 12/236,366

(22) Filed: Sep. 23, 2008

Related U.S. Application Data
(60) Provisional application No. 61/027,783, filed on Feb. 11, 2008.

(51) Int. Cl. G06F 3/038

(52) U.S. Cl. 345/212

(57) ABSTRACT

A method of tuning interferometric modulator display driving is disclosed. In one embodiment, the method comprising applying at least one voltage to an interferometric modulator display element, and while applying the voltage, adjusting a release and an actuation response time for the interferometric modulator. In another embodiment, the release and actuation response time are adjusted by adjusting the bias voltage applied to the device. Determining how to adjust the bias voltage may be done by measuring the current response of the device.

### CROSS-REFERENCE TO RELATED APPLICATIONS

This application claims the benefit under 35 U.S.C. 119(e) of U.S. Provisional Application Nos. 61/027,783, filed on Feb. 11, 2008, the disclosure of which is incorporated herein by reference in its entirety.

### DESCRIPTION OF THE RELATED TECHNOLOGY

Microelectromechanical systems (MEMS) include micro mechanical elements, actuators, and electronics. Micromechanical elements may be created using deposition, etching, and/or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

One embodiment disclosed herein includes a method of tuning interferometric modulator display driving, the method comprising applying at least one voltage to an interferometric modulator display element, and while applying the voltage, adjusting a release and an actuation response time for the interferometric modulator.

Another embodiment disclosed herein includes a method of tuning interferometric modulator display driving, the method comprising applying a bias voltage to interferometric modulator display elements in the display, applying driving voltages to interferometric modulator display elements in the display based on image data, wherein the driving voltages cause at least one interferometric modulator display element to change state, determining one or more values characteristic of response time for the at least one interferometric modulator display element change of state, and adjusting one or more of the bias voltage.

Another embodiment disclosed herein includes an interferometric modulator display, comprising a plurality of interferometric modulator display elements, a driving module configured to apply bias and driving voltages to the interferometric modulator display elements in response to image data, a current detector configure to measure current in response to the driving voltages, and a computation module configured to determine one or more values characteristic of response time for an interferometric modulator element change of state based on current measured by the current detector.

Still another embodiment disclosed herein includes a method of tuning interferometric modulator display driving, the method comprising applying a bias voltage to interferometric modulator display elements, wherein the bias voltage maintains the interferometric modulator display elements in an actuated or released state, determining one or more optical, mechanical, or electrical parameters characteristic of the value of the bias voltage relative to actuation and release voltages of the interferometric modulator display elements, wherein said determining does not cause the interferometric modulator display elements to change their state. comparing the one or more parameters with one or more reference parameters, and adjusting the bias voltage based on said comparing.

Another embodiment disclosed herein includes an interferometric modulator display, comprising a plurality of interferometric modulator display elements, a driving module configured to apply a bias voltage to the interferometric modulator display elements, a voltage waveform generator configured to apply a voltage waveform superimposed on the bias voltage, wherein the voltage waveform does not cause the interferometric modulator display elements to change their state, a detector configured to determine one or more optical, mechanical, or electrical parameters in response to the application of the voltage waveform, wherein the parameters are characteristic of the value of the bias voltage relative to actuation and release voltages of the interferometric modulator display elements, a memory storing one or more reference values for the optical, mechanical, or electrical parameters, and a computation module configured to compare the determined optical, mechanical or electrical parameters with the reference optical, mechanical, or electrical parameters and determine the bias voltage relative to actuation and release voltages of the interferometric modulator display elements.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is an explanatory diagram of movable mirror position versus applied voltage for one exemplary embodiment of an interferometric modulator of FIG. 1.

FIG. 4 is an illustration of a set of row and column voltages that may be used to drive an interferometric modulator display.

FIG. 5A illustrates one exemplary frame of display data in the 3×3 interferometric modulator display of FIG. 2.

FIG. 5B illustrates one exemplary timing diagram for row and column signals that may be used to write the frame of FIG. 5A.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8A-8D are graphs showing the effect of an applied voltage on the current measurement over a time period.

FIG. 9 is a flowchart demonstrating a method of adjusting the bias and/or driving voltages of an interferometric modulator.

FIG. 10 is a graph of capacitance versus applied voltage for one exemplary embodiment of an interferometric modulator of FIG. 1.

FIG. 11 is a flowchart demonstrating another method of adjusting the bias voltage of an interferometric modulator.

FIG. 12 is a block diagram illustrating an example system configured to drive a display array 102 and measure an electrical response of selected display elements, such as the interferometric modulator display device of FIG. 2.

FIG. 13 is a block diagram illustrating another example of circuitry that can be used to measure an electrical response of selected display elements via the same circuitry used to apply a stimulus to the selected display elements, such as in the interferometric modulator display device of FIG. 2.

### DETAILED DESCRIPTION OF THE PREFERRED EMBODIMENT

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

The behavior of an interferometric modulator in a display may change with the age of the display, temperature variations, etc. For example, the actuation time and the release time, which are the amount of time it takes for the interferometric modulator to actuate or release, can vary with the age of the display, temperature variations, or other changes. The actuation time and release time of an interferometric modulator depend on the bias and driving voltages used in the operation of the device relative to actuation and release voltages. Thus, the actuation time and release time of the interferometric modulator can be adjusted by adjusting the bias and driving voltages. These voltages may be adjusted periodically or continually throughout the life of a display such that they fit within predefined ranges, or such that the ratio of actuation time to release time falls within a predefined range. Measurement of the actuation time and release time can be direct or indirect. Directly, the response time of the device can be measured by actually changing the state of the device and determining how long the change of state takes. Indirectly, the position of the modulator along its hysteresis curve can be measured without changing state, and the value of the actuation time and the release time can be inferred from these measurements.

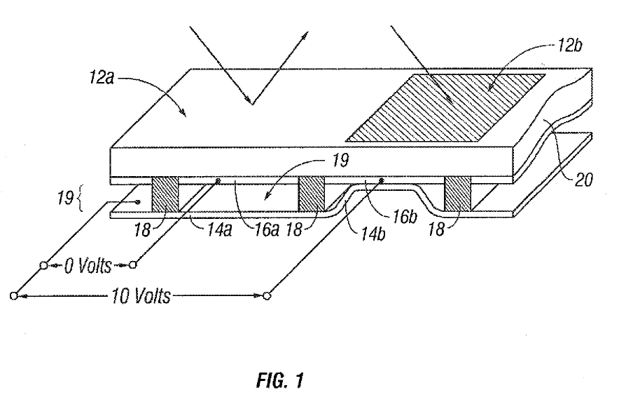

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

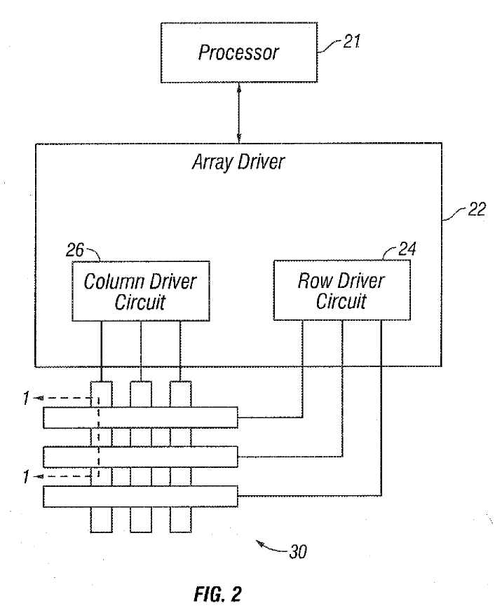

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

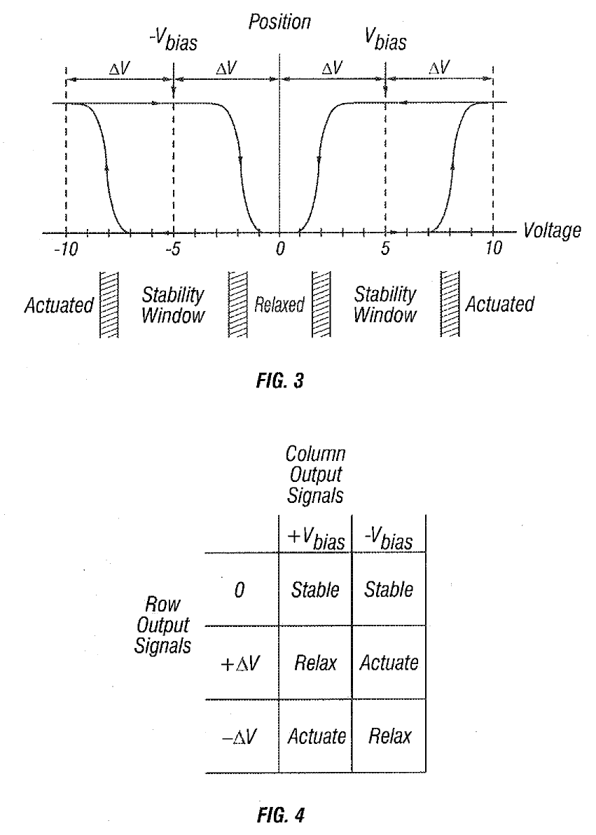

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

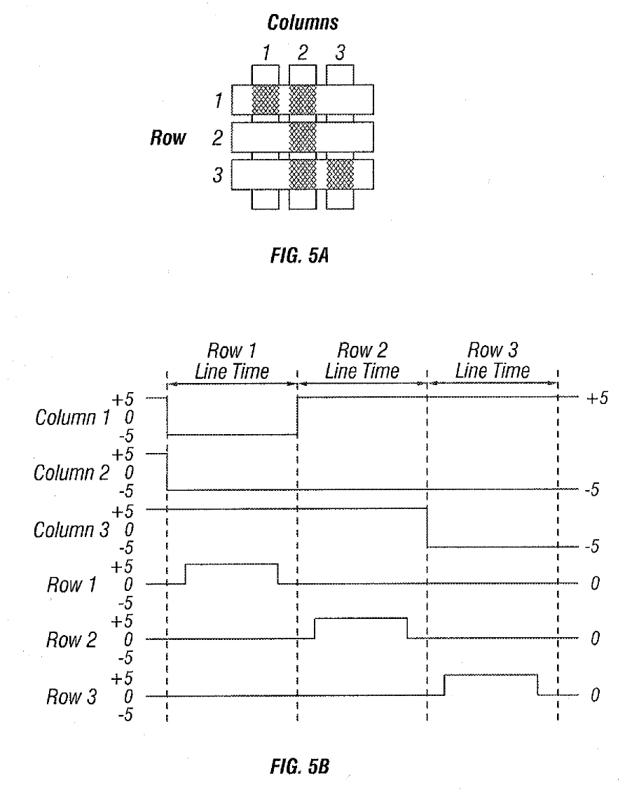

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

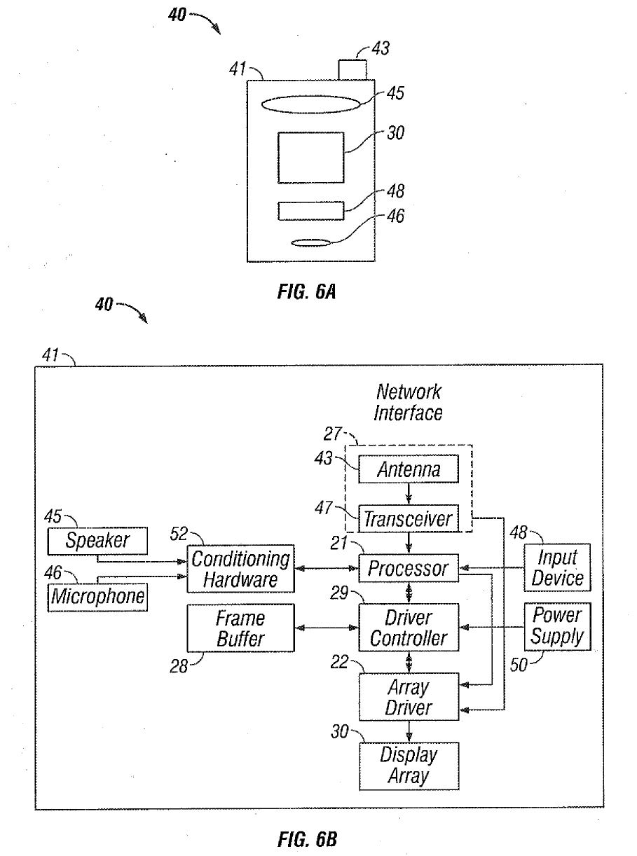

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

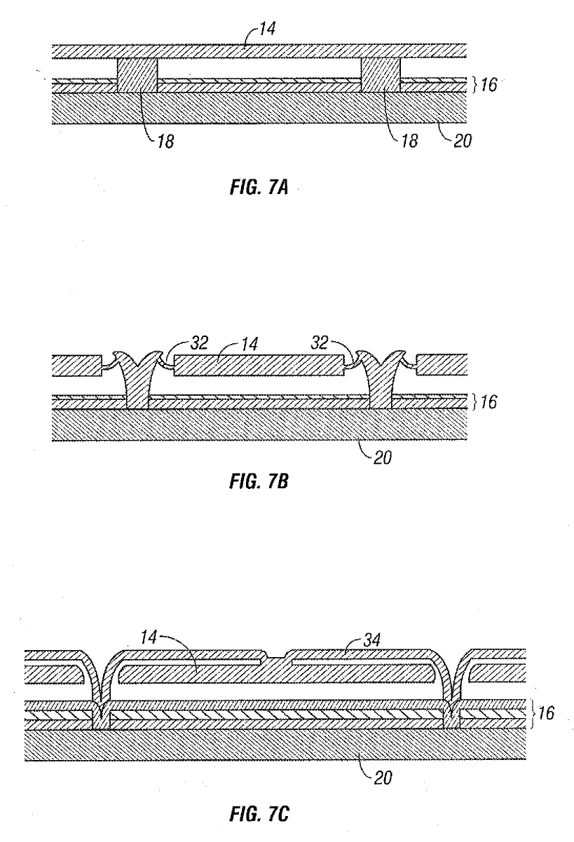

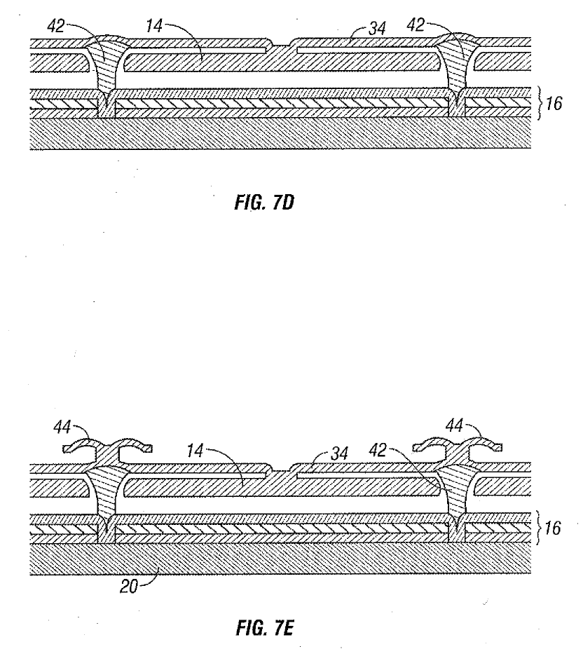

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

As noted above, the behavior of an interferometric modulator may change with the age of the display, temperature variations, etc. For example, the actuation time and the release time may vary with the above-mentioned parameters, or other parameters. Accordingly, in some embodiments, the bias and/or driving voltages used to drive an interferometric modulator are adjusted or “tuned” to achieve optimal actuation and release times. One embodiment includes determining a response time or value characteristic of a response time (e.g., a time constant) followed by tuning the bias voltage and/or the driving voltages of an interferometric modulator based on the determined response time.

Generally, the response times of interferometric modulators depend on the applied voltage level, both before and after actuation or release. For example, when a modulator held in the relaxed state is actuated by application of a square pulse crossing the modulator's actuation voltage, the actuation time of the modulator depends on the length of the pulse, the value of the initial bias voltage, and the applied actuation voltage in relation to the actuation and release voltages of the modulator. Similarly, when a modulator held in the actuated state is released by application of a square pulse crossing the modulator's release voltage, the release time of the modulator depends on the size of the pulse, the value of the initial bias voltage, and the applied release voltage in relation to the actuation and release voltages of the modulator. One embodiment includes a method which makes use of the relationship between response time and the above-described voltages to infer voltage tuning information from the interferometric modulator response times. Bias and/or driving voltages can be then adjusted to achieve desired actuation and release times.

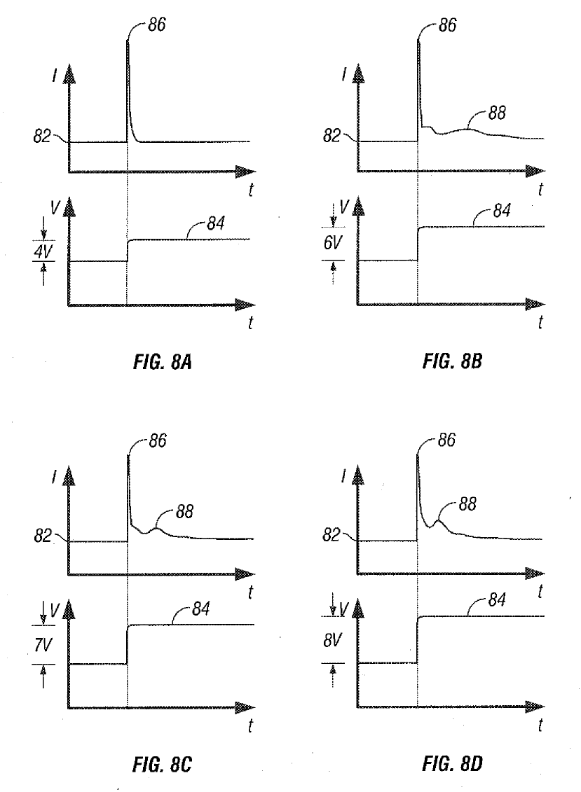

FIGS. 8A-8D are graphs respectively showing the current response 82 of an exemplary interferometric modulator device upon application of a voltage step 84 of various magnitudes. This illustrates that the response time depends on the voltage level of the applied step. As shown in FIGS. 8A-8D, when a voltage step 84 is applied to an interferometric modulator 12, there is a measurable current response 82. The initial voltage is assumed to be at a bias voltage sufficient to hold the interferometric modulator 12 in either an actuated or released state. The final voltage after the application of the voltage step may or may not cause a change in state (e.g., an actuation or a release) depending on its value relative to the actuation or release potentials of the interferometric modulator 12. In cases where the final potential is enough to cause actuation or release, in the resulting current may exhibit multiple peaks 86,88. In general, the current response 82 to a voltage step 84 can be described by the following equation:

$$I = \frac{d Q}{d t} = C \frac{d V}{d t} + V \frac{d C}{d t} .$$

The first term in this equation

$$( C \frac{d V}{d t} ) ,$$

which is due to capacitive charging prior to actuation or release, contributes primarily to a first, sharp peak 86, of the current response 82. The second term

$$( V \frac{d C}{d t} )$$

due to the change in capacitance caused by actuation or release, contributes primarily to a second, less sharp peak 88 of the current response 82. These peaks are apparent in FIGS. 8B-8D as discussed below.

FIG. 8A is a graph showing the current response 82 of an exemplary interferometric modulator upon application of a 4 volt pulse 84. In this case, 4 volts is not strong enough to actuate the device, and only a sharp peak 86 corresponding to the first term in the above equation is seen. FIG. 8B is a graph showing the current response 82 of the modulator upon application of a 6 volt pulse 84. In this case, the interferometric modulator 12 actuates, resulting in two peaks 86,88 in the current response 82. The first peak 86 is stronger than in the case of FIG. 8A because the change in voltage is greater. The second peak 88 results from the change in capacitance of the modulator as it changes states. FIG. 5C is a graph showing the current response 82 of the modulator upon application of a 7 volt pulse 84. Again, the first peak 86 is stronger than in the case of either FIG. 8A or 8B because the change in voltage is greater. The second peak 88, corresponding to a change of state in the modulator, is sooner, sharper, and with a greater magnitude than in the case of FIG. 8B. FIG. 8D is a graph showing the current response 82 of the modulator upon application of a 8 volt pulse 84. As before, the first peak 86 is stronger than in FIGS. 8A-8C, and the second peak 88 is sooner, sharper, and with a greater magnitude than in FIGS. 8B and 8C.

From the current response 82, a number of parameters characteristic of the response time can be defined. For example, the time between application of the pulse and the maximum of the second peak 88 of the current response may be used as a representation of the response time. Alternatively, the current response 82 can be integrated, with the area under the curve characteristic of response time. In another embodiment, the sharpness of the second peak 88 may be determined using techniques known in to those of skill in the art. For instance, the time between the second peak reaching 70% of the maximum and the second peak 88 decaying to 70% of the maximum may be used as a measure the sharpness of the second peak 88. Alternatively, the current response 82 can be fit to a curve determined by the above equation to determine time constants that are characteristic of the response time.

In some embodiments, the bias and/or driving voltages are adjusted until a parameter characteristic of response time (e.g., one of the parameters described above) are within a predefined range or a ratio of such parameters (e.g., the ratio of an actuation response time parameter to a release response time parameter) are within a predefined range. In some embodiments, the bias and/or driving voltages are adjusted until the actuation time and release time are approximately equal.

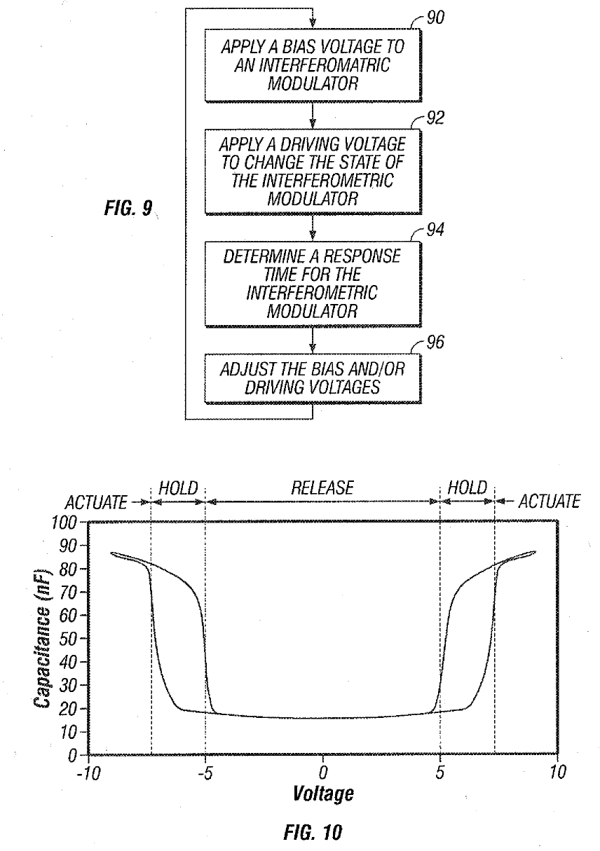

FIG. 9 is a flowchart showing one method of determining response times and then adjusting the bias and/or driving voltages of an interference modulator. Depending on the particular embodiment, steps may be added to those depicted in the flowcharts herein or some steps may be removed. In addition, the order of steps may be rearranged depending on the application. In the first stage 90, a bias voltage is applied to an interferometric modulator 12, placing the modulator 12 in the hold state. In a next stage 92, a driving voltage is applied to the modulator 12 to cause the modulator 12 to change state and the resulting current is detected. The current drawn from the interferometric modulator 12 during application of the driving voltage may be detected by any suitable method known to those of skill in the art. For example, the current may be detected by circuitry integrated into the array driver module 22. In a following stage 94, a response time for the modulator to either actuate or release is measured such as by one of the methods described above. A computer processor 21 may be used to analyze the current measured at stage 92 in order to determine response time or a value characteristic of the response time. In the final stage 96, the bias voltage and/or the driving voltages are adjusted based on the measured response time. In some embodiments, the bias voltage and/or driving voltages are adjusted iteratively by repeating the process of FIG. 9, each time altering the bias and/or driving voltages until the final desired response times are measured.

In some embodiments, the process described in FIG. 9 is conducted as part of the normal image writing process in an interferometric modulator display. For example, the application of bias and driving voltages may be in response to the receipt of image data which requires an interferometric modulator 12 to change state as part of the normal image writing process. Thus, the determination of response times may be conducted without altering the normal display driving timing. In some embodiments, the response times determined at stage 92 are determined by detecting the response current for all interferometric modulators or a grouping of interferometric modulators that change state as part of the image writing process. In other embodiments, the response current is individually detected and analyzed for each interferometric modulator 12.

Another embodiment includes a method that estimates the actuation or release potentials of a MEMS device such as an interferometric modulator 12 or the strength of the bias voltage applied to the MEMS device in relation to the actuation or release potentials, via optical, mechanical, or electrical methods without crossing the actuation or release voltages. This method estimates the relative position of the bias voltage applied to an interferometric modulator 12 within the hysteresis window without changing the state of the device. Thus, the method allows prediction of the actuation or release potentials of the device without having any non-negligible change in the visual state or color of the device.

Capacitance, as well as other parameters, in an interferometric modulator in the hold state, is a function of the applied bias voltage within the hysteresis window. In other words, these parameters vary within the hysteresis window depending on how close the applied bias voltage is to the actuation or release potential. Accordingly, in some embodiments, capacitance or another parameter is determined while an interferometric modulator 12 is held at the applied bias voltage. The bias and/or driving voltages may then be adjusted so that the desired relationship between bias, actuation, and release potentials (and hence actuation and release times) are obtained. For example, one may measure the reflectance of the modulator, the mechanical resonance frequency, a dimension of the space 19 between the two layers, or the capacitance of the device. Measuring one of these parameters can thus reveal the relative position of the bias voltage within the hysteresis window. In one embodiment, capacitance is measured by superimposing a small amplitude periodic waveform, such as a sine wave or a triangular wave, on top of the bias voltage and then measuring the periodic current response.

FIG. 10 is a diagram of capacitance versus applied voltage for one exemplary embodiment of an interferometric modulator of FIG. 1. In some embodiments, as shown in FIG. 10, the capacitance of an interferometric modulator 12 is not constant as a function of applied voltage when the interferometric modulator 12 is in either the actuation, hold, or release states. A similar response is observed for optical measurements (e.g., of the distance between the two reflective layers in the interferometric modulator 19). In addition, the resonance frequency of an interferometric modulator varies with the applied voltage. Thus, a number of parameters can be used to determine the relative position of an applied voltage within the hysteresis curve of an interferometric modulator.

Accordingly, in some embodiments the relative position of an applied voltage within the hysteresis curve (e.g., its position relative to actuation and release potentials) is estimated via measurement of optical, mechanical, or electrical parameters and subsequent comparison with a reference hysteresis curve (i.e., a model). In some embodiments, the model includes a data set that indicates the variation of the measurement parameter (e.g., capacitance) as a function of voltage. The model may be either theoretically derived or experimentally determined. Experimentally determined models may be constructed via explicit measurements of the desired measurement parameter in response to application of a full range of voltages on the device. If a theoretical model is used, the complete data set may be constructed using certain reference constants (e.g., the values of the chosen measurement parameter (such as capacitance) at zero voltage, high (actuating) voltage, etc.). These constants may be determined via theory, or via measurement of these parameters at another point in time on the same device, or via measurement of these parameters on a different interferometric modulator device.

After estimation of the position of the bias within the hysteresis window, the response time can inferred, and tuned. As the response time for actuation or release of an interferometric modulator 12 is dependent on the bias voltage and driving voltages, the bias voltage or driving voltages may be adjusted to change the actuation or release time. It may be advantageous to adjust the actuation time and release time of the interferometric modulator 12 to fit within predefined ranges, or such that the ratio of actuation time and release time falls within a predefined range.

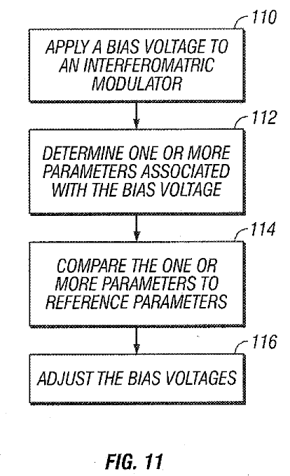

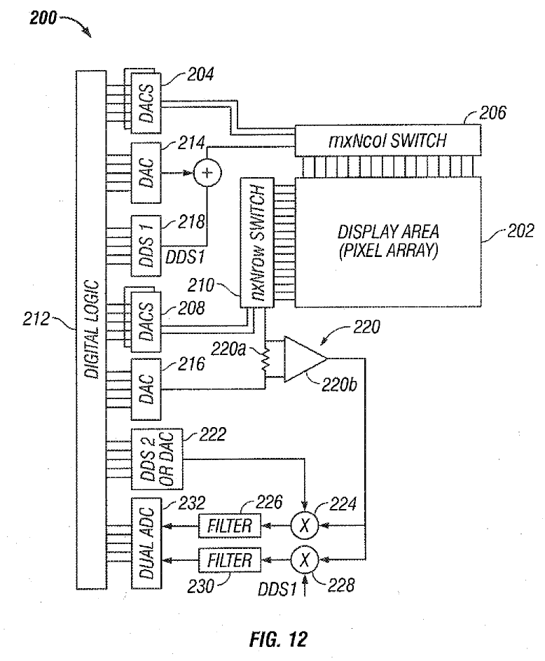

FIG. 11 is a flowchart showing another method of adjusting the bias voltage of an interference modulator. In the first stage 110, a bias voltage is applied to an interferometric modulator 12, placing the modulator 12 in the hold state. Next, at stage 112, one or more parameters that vary as a function of the applied bias voltage are determined (e.g., capacitance). In the following stage 114, the measured one or more parameters are compared with reference parameters. In the final stage 116, on the basis of the comparison, the bias and/or driving voltages are adjusted. In some embodiments, the measurements and adjustments may be conducted during normal operation of a display. For example, the process of FIG. 11 may be conducted during the period between image updating where only the bias potential is applied to the interferometric modulators.

The measurement of the electrical response of an interferometric modulator, such as the current response discussed above, can be obtained in a number of ways. For example, the electrical response can be measured when the interferometric modulator is part of an active display, such as a television. Appropriate circuitry for such measurement is now described. FIG. 12 is a block diagram illustrating an example system 200 configured to drive a display array 202 and measure an electrical response of selected display elements, such as the interferometric modulators 12a and 12b of FIG. 1. The display array 202 comprises N_{col} columns by N_{row} rows of N-component pixels (e.g., N may be 3 display elements including red, green and blue, for example). The system 200 further includes a column driver comprising two or more digital to analog converters (DAC) 204 for supplying two or more drive voltage levels as well as a switch subsystem 206 for selecting which columns to supply which signals. The system 200 further includes a row driver circuit comprising two or more DAC's 208 for supplying two or more drive voltage levels as well as a switch circuit 210 for selecting which row to strobe. Note that the row and column drivers that are directly connected to the display array in this schematic are composed of switches, but several methods discussed below are applicable to alternative driver designs including a full analog display driver.

The row and column driver circuitry, including the DAC's 204 and 208 and the switches 206 and 210, is controlled by an array driver 212. As discussed above in reference to FIGS. 2 and 3, the row/column actuation protocol contained in the digital logic of the array driver 212 may take advantage of a hysteresis property of interferometric modulator MEMS devices. For example, a display array comprising interferometric modulators 12 having the hysteresis characteristics of FIG. 3, the row/column actuation protocol can be designed such that during row strobing, display elements in the strobed row that are to be actuated are exposed to an actuation voltage difference (e.g., about 10 volts), and display elements that are to be relaxed are exposed to a voltage difference of close to zero volts. After the strobe, the display elements are exposed to a steady state voltage difference known as the bias voltage (e.g., about 5 volts) such that they remain in whatever state the row strobe put them in. After being written, each display element sees a potential difference within the “stability window” of 3-7 volts in this example. However, as discussed above, the characteristics of the display elements may change with time and/or temperature or may respond more quickly or slowly to different drive voltage levels. As such, the array driver 212 and the DAC's 204 and 208 may be configured to supply variable voltage levels, depending on the embodiment.

In addition to the drive circuitry discussed above (including the DAC's 204 and 208 and the switches 206 and 210, and the array driver 212), the remaining blocks of the system 200 are added to be able to apply further electrical stimulus to selected display elements (e.g., to apply a small amplitude periodic waveform in order to determine capacitance), as well as to be able to measure the electrical response of selected display elements in the display array 202. In this example, digital-to-analog converters (DACs) 214 and 216 supply additional voltages to the display array 202 via the column and row switches 206 and 210, respectively. In general, these may represent the internal or external voltage supply inputs to the row and column drive circuitry.

In this example, a direct-digital-synthesis (DDS1) block 218 is used to generate the electrical voltage stimulus that is added on the top of the voltage level produced by the DAC 214 connected to the column switch 206. Again, in general, the stimulus signal produced by the DDS1 block 218 may be produced by several alternative means like an electrical oscillator, a saw-tooth waveform generator, etc. which are familiar to those skilled in the art. It is also possible for the stimulus to be current or charge, or even a controlled output impedance.

In the example shown in FIG. 12, the electrical response is measured in the form of electrical current flowing through the display device resulting from application of the electrical voltage stimulus to the row and/or column electrodes via the row and/or column switches 206 and 210, respectively. A trans-impedance amplifier 220 (shown in FIG. 12 as a resistor 220A immediately followed by an amplifier 220B) may be used to measure the electrical response. The display element(s) for which the measured electrical response corresponds, depends on the states of the column and row switches 206 and 210. Analog, digital, or mixed-signal processing may be used for the purpose of measurement of the electrical response of the display device.

In one embodiment, the electrical response of a display element is measured directly by measuring the current of the output of the trans-impedance amplifier 220. In this embodiment, the profile and/or peak values, or other characteristics known to skilled technologists, can be used to identify certain operational characteristics of the display element.

In another embodiment, operational characteristics of the display element being measured can be characterized by additional post processing of the electrical response output from the trans-impedance amplifier 220. An example of using post processing techniques to characterize the capacitance and the resistive component of the impedance of an interferometric modulator using the circuitry of FIG. 12 is now discussed.

Since an interferometric modulator functions as a capacitor, a periodic stimulus, such as that which could be applied using the DDS1 218, will result in a periodic output electrical response with a 90° phase lag. For example, the DdS1 218 could apply a sinusoidal voltage waveform, say sin(ωt), to the column electrode of the display element. For an ideal capacitor, the electrical response of the display element would be a time derivative of the applied stimulus, proportional to cos(ωt). Thus, the output of the trans-impedance amplifier 220 would also be a cosine function. A second DDS, DDS2 222, applies a cosine voltage waveform that is multiplied by the output of the trans-impedance amplifier 220 at multiplier 224. The result is a waveform with a constant component and a periodic component. The constant component of the output of the multiplier 224 is proportional to the capacitance of the display element. A filter 226 is used to filter out the periodic component and result in an electrical response that is used to characterize the capacitance. This capacitance, as described, can be used to tune or adjust the bias and/or driving voltages of the interferometric modulator.

For a display element that is an ideal capacitor, the output of the trans-impedance amplifier 220 is a pure cosine function for the example where the applied stimulus is a sine function. However, if the display element exhibits impedance, due to leakage for example, the output of the trans-impedance amplifier 220 will also contain a sine component. This sine component does not affect the measurement of the capacitance, since it will be filtered out by the filter 226. The sine component can be used to characterize the resistive portion of the impedance of the display element.

A periodic voltage waveform similar to the stimulus applied by the DDS1, sin(wt) for example, is multiplied by the output of the trans-impedance amplifier 220 at a multiplier 228. The result is an electrical response that includes a constant component and a periodic component. The constant component is proportional to the resistive portion of the impedance of the display element being measured. A filter 230 is used to remove the periodic component resulting in a signal that can be used to characterize the resistive portion of the impedance of the display element.

The outputs of the filters are converted to the digital domain by use of a dual analog to digital converter (ADC) 232. The output of the dual ADC 232 is received by the array driver 212 for use in the methods discussed above.

In the example circuitry shown in FIG. 12, the stimulus is applied to a column electrode and the electrical response is measured via a row electrode. In other embodiments, the electrical response can be measured from the same electrode, row or column, for example, to which the stimulus is applied.

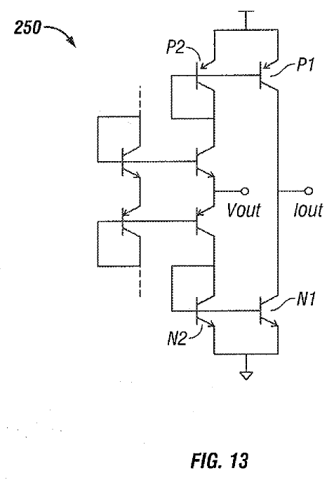

FIG. 13 is a block diagram illustrating an example of circuitry 250 that can be used to measure an electrical response of selected display elements via the same circuitry used to apply a stimulus to the selected display elements, such as in the interferometric modulator display device of FIG. 2. The circuit 250 comprises transistors N1 and P1 which mirror the current from the current source transistors N2 and P2 used to drive the Vₒᵤₜ signal applied to the display element. Accordingly, the current Iₒᵤₜ is substantially equal to the current used for driving the Vₒᵤₜ signal. Measuring the electrical response of the Iₒᵤₜ signal may, therefore, be used to determine operational characteristics of the interferometric modulators, such as the capacitance of the interferometric modulators. Other circuits may also be used. The circuit 250 shown in FIG. 13 is applicable to alternative driver IC designs or drive schemes for supplying a voltage waveform Vₒᵤₜ. The circuit 250 depicted in the schematic of FIG. 13 can be used in current conveyor circuits and in current feedback amplifiers, and can apply an electrical voltage stimulus to the display array area and simultaneously replicate the current (response) to a different pin (Tout) for purposes of electrical sensing.

There are various methods of sensing different portions of a display array of display elements. For example, it may be chosen to sense an entire display array in one test. In other embodiments, only a representative portion of the display is selected to be sensed. Feedback signals from all the selected row electrodes (or column electrodes) may be electrically connected to the trans-impedance amplifier 220 shown in FIG. 12. In this case, the timing of the column electrodes being signaled to, and the rows being signaled to, may be synchronized by the array driver 212 such that individual display elements, pixels or sub-pixels (e.g., red, green and blue sub-pixels) may be monitored at certain times. It may also be chosen to monitor or measure one or more specific row or column electrodes at one time and optionally switching to monitor other row and column electrodes until the selected portion of the array is monitored. Finally, it may also be chosen to measure individual display elements and optionally switching to monitor or measure the other display elements until the selected portion of the array is measured.

In one embodiment, one or more selected row or column electrodes may be permanently connected to the stimulus and/or sense circuitry while the remaining ones are not. It is also possible to purposefully add extra electrodes (row or column) to the display area for the purpose of applying the stimulus or sensing. These other electrodes may or may not be visible to a viewer of the display area. Finally, another option is to be able to connect and disconnect the stimulus/drive and/or sense circuitry to a different set of one or more row or column electrodes via switches or alternative electrical components.

Embodiments of the systems and methods discussed above may be applied to monochrome, bi-chrome, or color displays. It is possible to measure groups of pixels for different colors by suitable choice of row and column electrodes to apply drive voltages to and/or to sense from. For example, if the display uses RGB layout where Red (R), Green (G), and Blue (B) sub-pixels are located on different column lines, areas of individual colors may be measured via application of stimulus only to the ‘Red’ columns and sensing on the rows. Alternatively, the stimulus may be applied to the rows, but sensed only on the ‘Red’ columns.

Although the invention has been described with reference to embodiments and examples, it should be understood that numerous and various modifications can be made without departing from the spirit of the invention. Accordingly, the invention is limited only by the following claims.

What is claimed is:

1. A method of tuning voltages for driving a microelectromechanical system (MEMS) array, the method comprising:
applying at least one voltage to aMEMS element; and
while applying the voltage, adjusting a release and an actuation response time for the MEMS element.

2. The method of claim 1, wherein the MEMS array is an interferometric modulator display and the MEMS element is an interferometric modulator.

3. The method of claim 2, wherein the applied voltage is based on image data.

4. The method of claim 1, wherein the applied voltage comprises a bias voltage that maintains the MEMS element in one or more of an actuated and a released state.

5. The method of claim 1, wherein the applied voltage comprises driving voltages cause the MEMS element to change state between an actuated and released state.

6. A method of tuning voltages for driving an interferometric modulator display, the method comprising:
a) applying one or more bias voltages to one or more interferometric modulator display elements in the display, wherein the bias voltage maintains the one or more interferometric modulator display elements in one or more of an actuated and a released state;
b) applying driving voltages to one or more interferometric modulator display elements in the display based on image data, wherein the driving voltages cause at least one interferometric modulator display element to change state between an actuated and released state;
c) determining one or more values characteristic of response time for the at least one interferometric modulator display element change of state; and
d) adjusting one or more of the bias voltage or driving voltages based on the values characteristic of response time.

7. The method of claim 6 further comprising determining one or more values characteristic of response time for interferometric modulator actuation and one or more values characteristic of response time for interferometric modulator release.

8. The method of claim 7, further comprising selecting a different bias voltage such that the one or more values characteristic of response time for interferometric modulator actuation is within a first predetermined range and the one or more values characteristic of response time for interferometric modulator release is within a second predetermined range.

9. The method of claim 7, further comprising selecting a different bias voltage such that a ratio of the one or more values characteristic of response time for interferometric modulator actuation to the one or more values characteristic of response time for interferometric modulator release is within a predetermined range.

10. The method of claim 6, further comprising repeating steps a) through d) one or more times to obtain one or more values characteristic of response time for a plurality of bias voltages.

11. The method of claim 10, further comprising selecting a different bias voltage based on said obtained values characteristic of response time for said plurality of bias voltages.

12. The method of claim 6, wherein determining the one or more values characteristic of response time comprises measuring current drawn by at least one interferometric modulator display element in response to the driving voltage.

13. The method of claim 6, wherein determining the one or more values characteristic of response time comprises detecting a change in light modulation from the at least one interferometric modulator display element in response to the driving voltage.

14. The method of claim 6, wherein the one or more values characteristic of response time comprises a time constant.

15. An interferometric modulator display, comprising:
a plurality of interferometric modulator display elements;
a driving module configured to apply one or more bias and driving voltages to one or more of the interferometric modulator display elements in response to image data;
a current detector configure to measure current drawn by the one or more interferometric modulator display elements in response to the driving voltages; and
a computation module configured to determine one or more values characteristic of response time for an interferometric modulator element change of state based on the current measured by the current detector.

16. The display of claim 15, comprising memory configured to store a plurality of values characteristic of response time for an interferometric modulator element change of state.

17. The display of claim 15, further comprising:
a processor that is in electrical communication with said display elements, said processor being configured to process image data; and
a memory device in electrical communication with said processor.

18. The display of claim 17, further comprising:
a first controller configured to send at least one signal to said display elements; and
a second controller configured to send at least a portion of said image data to said first controller.

19. The display of claim 17, further comprising an image source module configured to send said image data to said processor.

20. The display of claim 19, wherein said image source module comprises at least one of a receiver, transceiver, and transmitter.

21. The display of claim 17, further comprising an input device configured to receive input data and to communicate said input data to said processor.

22. An interferometric modulator display, comprising:
means for interferometrically modulating light;
means for applying one or more bias and driving voltages to the light-modulating means in response to image data;
means for measuring current drawn by the light-modulating means in response to the driving voltages; and
means for determining one or more values characteristic of response time for the light-modulating means' change of state based on the current measured by the current-measuring means.

23. The display of claim 22, wherein the means for interferometrically modulating light comprises a plurality of interferometric modulator display elements.

24. The display of claim 22, wherein the means for applying one or more bias and driving voltages comprises a driving module.

25. The display of claim 22, wherein the means for measuring current comprises a current detector.

26. The display of claim 22, wherein the means for determining one or more values characteristic of response time comprises a computation module.

27. A method of tuning voltages for driving an interferometric modulator display without changing interferometric modulator state, the method comprising:
applying a bias voltage to one or more interferometric modulator display elements, wherein the bias voltage maintains the one or more interferometric modulator display elements in one or more of an actuated and a released state;
determining one or more optical, mechanical, or electrical parameters characteristic of the value of the bias voltage relative to actuation and release voltages of the one or more interferometric modulator display elements, wherein said determining does not cause the one or more interferometric modulator display elements to change their state;
comparing the one or more parameters with one or more reference parameters; and
adjusting the bias voltage based on said comparing.

28. The method of claim 27, wherein the one or more optical, mechanical, or electrical parameters comprise capacitance of the one or more interferometric modulator display elements.

29. The method of claim 28, further comprising determining the capacitance by varying the voltage applied to the one or mote interferometric modulator display elements and measuring a current drawn by the one or more interferometric modulator display elements.

30. The method of claim 29, wherein varying the voltage comprises applying a periodic voltage waveform superimposed over the bias voltage.

31. The method of claim 30, wherein the periodic voltage waveform comprises a sinusoidal waveform.

32. The method of claim 27, wherein the one or more optical, mechanical, or electrical parameters comprise reflectance.

33. The method of claim 27, wherein the one or more optical, mechanical, or electrical parameters comprise mechanical resonance frequency.

34. The method of claim 27, wherein the one or more optical, mechanical, or electrical parameters comprise a value characteristic of mechanical response time.

35. The method of claim 27, wherein the bias voltage is adjusted to be within a pre-determined range of relative to the actuation and release voltages.

36. An interferometric modulator display, comprising:
a plurality of interferometric modulator display elements;
a driving module configured to apply a bias voltage to the interferometric modulator display elements, wherein the bias voltage maintains the interferometric modulator display elements in one or more of an actuated and a released state;
a voltage waveform generator configured to apply a voltage waveform superimposed on the bias voltage, wherein the voltage waveform does not cause the interferometric modulator display elements to change their state between an actuated and released state;
a detector configured to determine one or more optical, mechanical, or electrical parameters in response to the application of the voltage waveform, wherein the parameters are characteristic of the value of the bias voltage relative to actuation and release voltages of the interferometric modulator display elements;
a memory storing one or more reference values for the optical, mechanical, or electrical parameters; and
a computation module configured to compare the determined optical, mechanical, or electrical parameters with the reference optical, mechanical, or electrical parameters and determine the bias voltage or an adjustment to the bias voltage relative to actuation and release voltages of the interferometric modulator display elements.

37. The display of claim 36, wherein the detector is a current detector.

38. The display of claim 36, wherein the detector is a light detector.

39. The display of claim 36, wherein the memory stores optical, mechanical, or electrical parameters as a function of voltage relative to actuation and release voltages and as a function of interferometric modulator state.

40. The display of claim 36, further comprising:
a processor that is in electrical communication with said display elements, said processor being configured to process image data; and
a memory device in electrical communication with said processor.

41. The display of claim 40, further comprising:
a first controller configured to send at least one signal to said display elements; and
a second controller configured to send at least a portion of said image data to said first controller.

42. The display of claim 40, further comprising an image source module configured to send said image data to said processor.

43. The display of claim 42, wherein said image source module comprises at least one of a receiver, transceiver, and transmitter.

44. The display of claim 40, further comprising an input device configured to receive input data and to communicate said input data to said processor.

45. An interferometric modulator display, comprising:
means for interferometrically modulating light;
means for applying a bias voltage to the light-modulating means, wherein the bias voltage maintains the light-modulating means in one or more of an actuated and a released state;
means for applying a voltage waveform superimposed on the bias voltage, wherein the voltage waveform does not cause the light-modulating means to change state between an actuated and released state;
means for determining one or more optical, mechanical, or electrical parameters in response to the application of the voltage waveform, wherein the parameters are characteristic of the value of the bias voltage relative to actuation and release voltages of the light-modulating means;
means for storing one or more reference values for the optical, mechanical, or electrical parameters; and
means for comparing the determined optical, mechanical, or electrical parameters with the reference optical, mechanical, or electrical parameters and determining the bias voltage or an adjustment to the bias voltage relative to actuation and release voltages of the light-modulating means.

46. The display of claim 45, wherein the means for interferometrically modulating light comprises a plurality of interferometric modulator display elements.

47. The display of claim 45, wherein the means for applying a bias voltage comprises a driving module.

48. The display of claim 45, wherein the means for applying a voltage waveform comprises a voltage waveform generator.

49. The display of claim 45, wherein the means for determining one or more optical, mechanical, or electrical parameters comprises a detector.

50. The display of claim 45, wherein the means for storing one or more reference values comprises a memory.

51. The display of claim 45, wherein the means for comparing the determined optical, mechanical, or electrical parameters with the reference optical, mechanical, or electrical parameters comprises a computation module.
